(19) United States
(12) Patent Application Publication
(10) Pub. No.: US 2006/0029281 A1
(43) Pub. Date: Feb. 9, 2006

(54) Digital image processing method for low-rate applications

(75) Inventors: Arnaud Bourge, Paris (FR); Joel Jung, Guyancourt (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/511,810

(22) PCT Filed: Apr. 16, 2003
(86) PCT No.: PCT/IB03/01564

§ 371 Date: Oct. 19, 2004

(30) Foreign Application Priority Data
Apr. 23, 2002 (FR) 02/05087

(51) Int. Cl. G06K 9/36

(52) U.S. Cl. 382/250

(57) ABSTRACT

The present invention relates to a method of processing digital images (30) comprising data blocks, said method including a step of determining (31) a homogeneous region containing two adjacent blocks (Bj, Bk) whose continuous components (Lj, Lk) differ by a value lower than a predetermined threshold. It also includes a step of determining (32) a segment to be corrected (Sjk) which comprises a set of initial data on either side of a border separating the adjacent blocks. The method finally comprises a step of replacing (33) the set of initial data of the segment to be corrected by a set of corrected data (S′jk) chosen at random from various possible corrected data sets (34), an average value of a corrected set of data being substantially equal to an average value of the continuous components of the two adjacent blocks.

### FIELD OF THE INVENTION

The present invention relates to a method of processing digital images comprising data blocks, said method including a step of determining a homogeneous region which contains two adjacent blocks whose continuous components differ by a value lower than a predetermined threshold, and a step of determining a segment to be corrected comprising a set of initial data on either side of a border separating the adjacent blocks.

The invention also relates to a processing device implementing such an image processing method.

The invention notably finds its application in the domain of low-rate video coding. The coding technique is based, for example, on the H.26L standard or an equivalent standard, thanks to which a sequence of digital images is previously coded and then decoded in the form of data blocks, the present invention permitting the correction of the decoded data blocks in order to attenuate the visual artefacts caused by the block-based coding technique. Thus, the invention could advantageously be integrated in portable appliances such as mobile telephones or personal digital assistants.

### BACKGROUND OF THE INVENTION

With the booming of the Internet and portable appliances it has turned out to be necessary to transmit video data over mobile networks for low-rate and real-time applications. Coding techniques have been implemented for this type of applications such as, for example, the MPEG-4 or H.26L standards, these techniques being based on a discrete block transformation. Techniques for correcting blocking effects have been developed in parallel, more specifically dedicated to low rates so as to correct the blocking artefacts due to these block-based coding techniques.

Conventional correction methods do not always turn out to be effective, more particularly in uniform and moderately contrasted areas. This finding is based on FIG. 1. It diagrammatically shows a reference function f that represents the difference of minimum luminance values AL visible by a viewer as a function of the average luminance AvgL of an image area, said area being substantially equal to the surface covered by a pair of adjacent blocks, for example. This function passes through a minimum ΔL0 equal to about 1 or 2 units, for an average luminance unit L0 equal to about 70 if the luminance is situated between 0 and Lmax=255. This function f is described more exactly in the article by H. R Wu and M. Yuen entitled “A generalized block-edge impairment metric for video coding” and published in IEEE Signal Processing Letters, vol. 4, n. 11, pp. 317-320, November 1997. A filtering thus turns out to be useless or almost useless for suppressing this type of visual defect.

International patent application WO 2001/58169 (internal reference PHFR000011) discloses an image processing method intended to reduce such visual defects. To this end it comprises the steps of:
low-pass filtering, a linear filtering, for example, of the data of an input image,
determining a segment to be corrected which comprises a set of filtered data on either side of a border separating the adjacent blocks,
correcting by adding a random binary number of at least 1 bit to the filtered data belonging to a segment to be corrected.

The addition of a random binary number, which is equivalent to a variable noise, permits to reduce the visibility of blocking artefacts, notably because the added noise is generally different from a current segment to be corrected relative to the segment to be corrected that immediately follows. However, the prior-art method may sometimes turn out to be ineffective because of the totally random character of the noise generation.

### SUMMARY OF THE INVENTION

It is an object of the present invention to propose a digital image processing method which is more effective.

Actually, many noise configurations are generated at random by the prior-art method, for example 16 in the case of a segment to be corrected that comprises 4 initial data and an added binary number of 1 bit. Certain configurations are not suitable of necessity, not to say turn out to be ineffective.

Therefore, the digital image processing method according to the invention is characterized in that it further comprises a step of replacing the set of initial data of the segment to be corrected by a set of corrected data, said set being chosen at random from various corrected sets of data, an average value of a set of corrected data being substantially equal to an average value of continuous components of the two adjacent blocks.

Thus, only the configurations are retained that correspond to an average value of a set of corrected data substantially equal to an average value of the continuous components of the two adjacent blocks. In the case of the segment to be corrected comprising 4 initial data with a difference of 1 luminance unit between the adjacent blocks, only 5 configurations are then retained from the possible 16. The fact of replacing the initial data of the segment to be corrected with such a configuration permits to not artificially add additional defects to the image content, contrary to the prior-art technique where a random binary number could give the value of a data of the corrected segment that is higher than the difference of the continuous components of the two blocks and where, in consequence, the average value of the set of corrected data was rarely equal to the average value of the continuous components of the two adjacent blocks.

Such a measure renders the method particularly simple and efficient, where the various configurations corresponding to the various sets of corrected data may be stored in the memory in advance or generated at random while taking into account the criterion relating to the average value of the corrected data of a set.

The present invention also relates to a decoding method comprising such a method of processing digital images and the video decoder implementing said decoding method.

The present invention also relates to a coding method comprising such a method of processing digital images and the video coder implementing said coding method.

The present invention finally relates to a computer program product implementing the invented method of processing digital images.

### BRIEF DESCRIPTION OF THE DRAWINGS

These and other aspects of the invention are apparent from and will be elucidated, by way of non-limitative example, with reference to the embodiment(s) described hereinafter.

In the drawings:

FIG. 1 illustrates diagrammatically a function representing the difference of minimum luminance values which are visible by a viewer as a function of the average luminance of an image area,

FIG. 2 represents a pair of adjacent blocks,

FIG. 3 is a block diagram of the digital image processing method according to the invention,

FIG. 4 represents various sets of possible corrected data corresponding to the use of the invention,

FIG. 5 is a block diagram of a complete method of processing digital images according to the preferred embodiment of the invention,

FIG. 6 describes a sub-block considered inside a block for the choice of a class within a classification step,

FIG. 7 represents associations of pairs of classes and of a filter as a function of a degradation measure,

FIG. 8 represents four smoothing filters which may be used in an advantageous manner by the digital image processing method according to the invention,

FIG. 9 is a block diagram of the decoding method including the digital image processing method according to the invention, and

FIG. 10 is a block diagram of the coding method including the digital image processing method according to the invention.

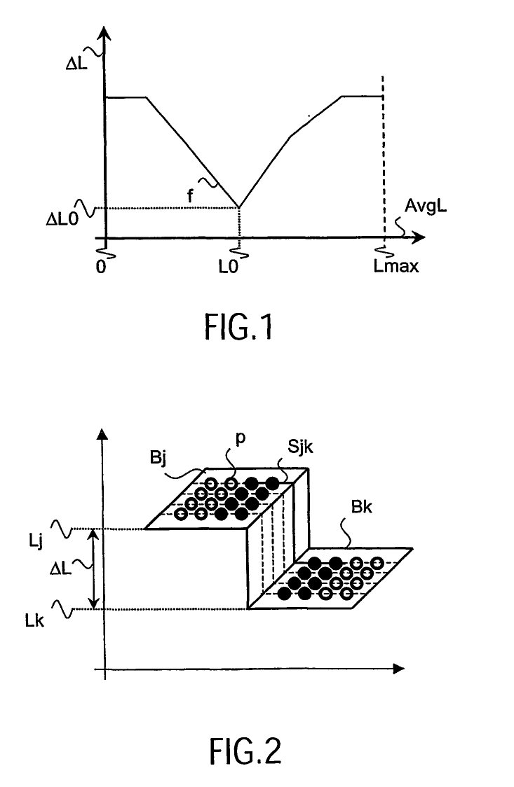

### DETAILED DESCRIPTION OF AT LEAST ONE EMBODIMENT OF THE INVENTION

The present invention relates to a method of processing a sequence of digital images coded and decoded according to a block-based coding technique, notably for low-rate and real-time applications. The coding technique used is in our example the H.26L standard, but may also be the MPEG-4 standard or any other equivalent standard. It is to be observed that this method could also be applied to a fixed image coded, for example, according to JPEG standard.

Such a block-based coding technique breaks down a digital image into blocks. In the case of the H.26L standard said blocks are 4 rows of 4 pixels. During the coding said blocks are then subjected to a frequency transformation. In the case of the H.26L standard and of most of the conventional techniques this is the Discrete Cosine Transform (DCT). During the decoding, blocking effects may appear along the borders of the blocks. A blocking effect resembles an edge but it does not really exist in the contents of the image proper. It is notably an object of the invention to eliminate these “false” edges situated along the borders of the blocks when they correspond to very low values of luminance difference but which are nevertheless visible under certain observation conditions, for example, on a screen that has high definition, after certain manipulations of the digital image format or also depending on the luminance levels of said image.

Let us suppose that a pair of adjacent blocks Bj and Bk of pixels p have a predetermined average luminance value Lj and Lk respectively, and a luminance difference value ΔL as represented in FIG. 2. This luminance difference is either the exact value between the two blocks if each of the two blocks is uniform. This may in the case of nearly uniform blocks also be the difference between the average luminance values of the two blocks or also the minimum or maximum difference between the two blocks if one wishes to save on calculation resources.

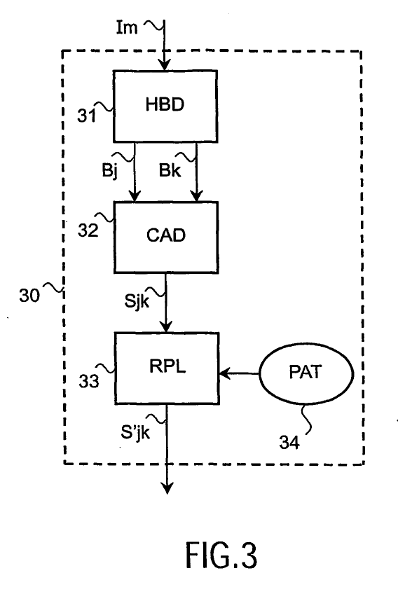

FIG. 3 describes the digital image Im processing method according to the invention. Said method comprises:
a determining step HBD (31) of determining a homogeneous region containing two adjacent blocks Bj and Bk whose continuous luminance components Lj and Lk differ by a value lower than a predetermined threshold equal to one or two luminance units in our example, that is to say:
   Lj=Lk±1 or Lj=Lk±2,
a determining step CAD (32) of determining a segment to be corrected Sjk which comprises a set of initial data on either side of a border separating the adjacent blocks; in the example of FIG. 2 this is a segment of 4 pixels with 2 pixels on either side of the border,
a replacing step RPL (33) of replacing the set of initial data of the segment to be corrected with a set S′jk of corrected data L′1 to L′4, said set being chosen at random from various possible sets of corrected data PAT (34), an average value M of a set of corrected data L′1 to L′4 being equal to the average value of the continuous components of the two adjacent blocks, that is to say:
   M=(L′1+L′2+L′3+L′4)/4=(Lj+Lk)/2.

Preferably the corrected data L′1 to L′4 continue to be situated between the luminance values Lj and Lk.

The replacing step is intended to be applied to various segments to be corrected overlapping the two adjacent blocks, that is here 4 segments in the case of the H.26L standard. A corrected segment S′jk, is chosen at random from various possible configurations. The probability of each corrected segment to be different from the segment that follows or immediately precedes is high, which leads to the fact that the initially present blocking artefact is smoothed out a little more.

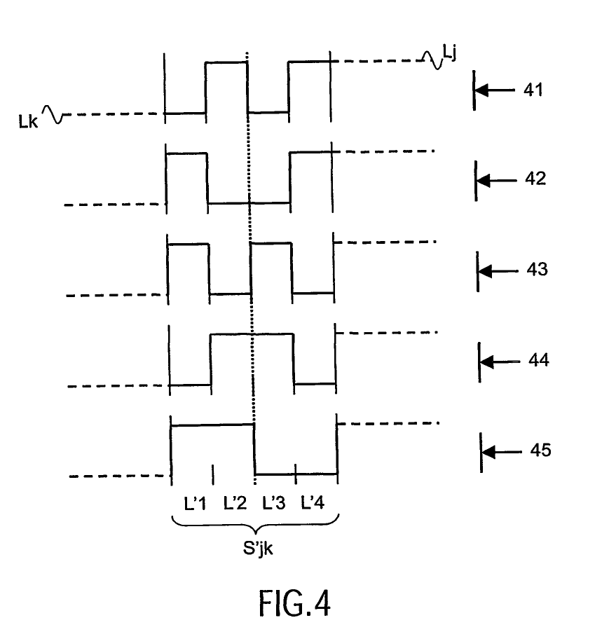

FIG. 4 represents the various possible corrected data sets corresponding to the implementation of the invention, that is to say 5 configurations for a segment to be corrected of 4 pixels and for a luminance difference value ΔL equal to 1. For the 4 first configurations (41-44) the average value of each half of the set of corrected data on either side of the border of the blocks is equal to the average value of the continuous components of the two adjacent blocks. The fifth configuration (45) corresponds to another configuration that may be envisaged where the average value of the set of corrected data is equal to the average value of the continuous components of the two adjacent blocks.

The image processing method according to the invention is applied for horizontally and vertically adjacent blocks. It generally follows a low-pass filter step, for example a linear filtering, which has turned out to be ineffective for correcting a luminance difference of 1 or 2 luminance units between the adjacent blocks. The following of the description discusses a complete image processing method including the image processing method according to the invention and a particularly simple and effective filter method. However, it will be obvious to persons skilled in the art that the present invention is not limited to this type of filtering.

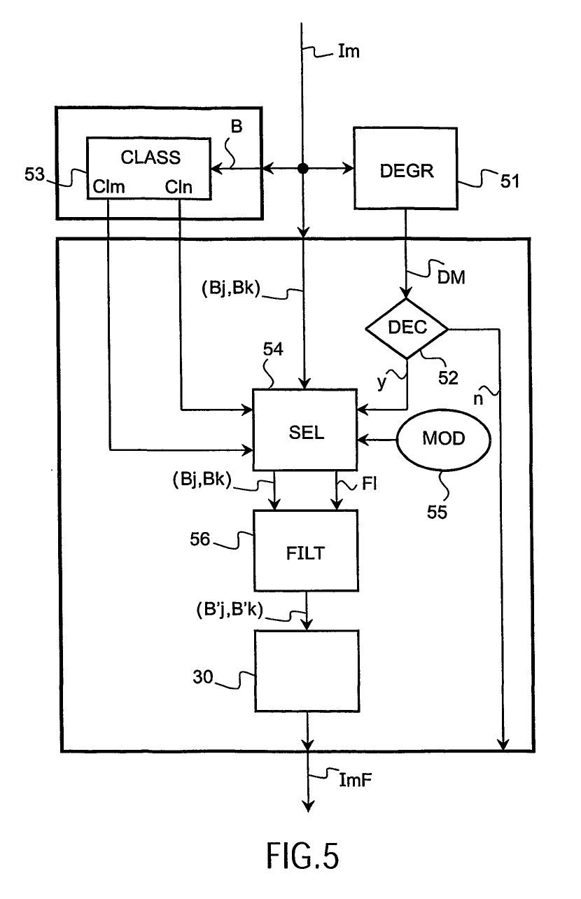

The processing method described above may thus be integrated with a complete image processing method as illustrated in FIG. 5. The method which is described in more detail in still unpublished French patent application 02 00487 comprises the following steps.

A decoded digital image Im is first presented to the input of a degradation evaluation step DEGR (51) which delivers a degradation measure DM of the digital image Im. The degradation measure DM corresponds, for example, to the value of an image quantization step or also to a substantially modified value of said quantization step as a function of characteristic features known from the coding technique used.

A filter decision step DEC (52) based on the degradation measure DM then follows. Said step decides for a pair of adjacent blocks (Bj,Bk) of the image Im and for the degradation measure DM whether a filter step is needed or not. The decision to filter is made, for example, according to the following criterion:
if the maximum luminance difference between the blocks Bj and Bk is smaller than 1.5 times the degradation measure DM, then the decision to filter is positive (y). In this case it is thus considered that not a real edge is concerned,
if not, it is negative (n). This time the maximum luminance difference between the blocks is considered high enough for a real edge corresponding to a natural contour that does not need filtering.

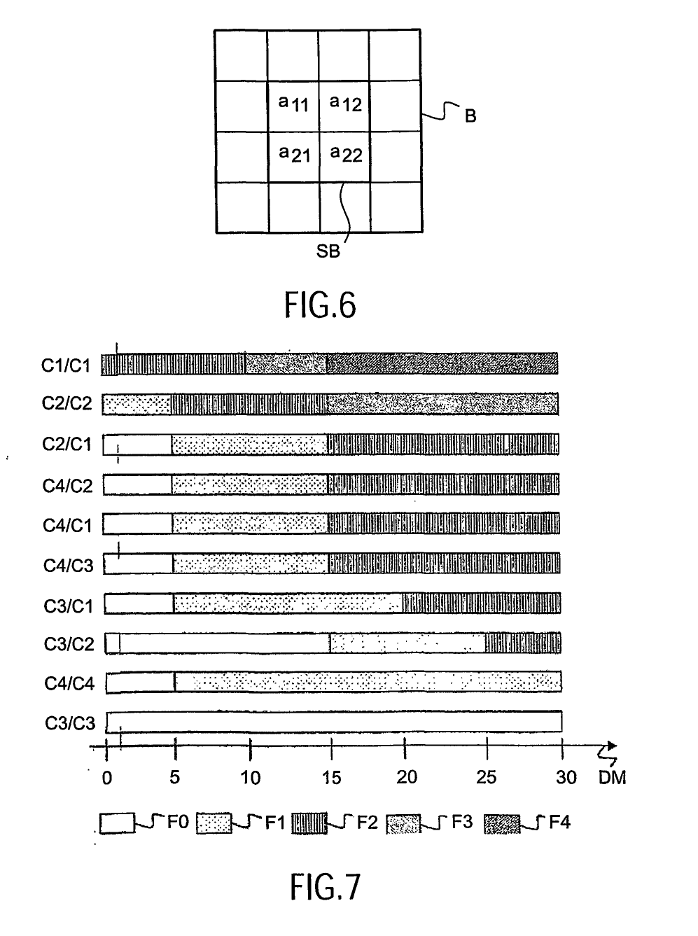

In parallel with the degradation evaluation step DEGR (51) and filter decision step DEC (52), the image Im is presented block by block to a classification step CLASS (53). The classification step CLASS (53) associates with a block B, a class Cli chosen from a set of predefined classes, 4 classes Cl1 to Cl4 in our example.
The block B belongs to the homogeneous class Cl1 if it satisfies the following conditions:
   |m₁-m₂|<S, with:
   m₁=max{a_{pq}}_{p=1.P-2,q=1 . . . Q-2} and m₂=min{a_{pq}}_{p=1 . . . P-2,q =1 . . . Q-2}.
   i.e. m1 is the maximum of the coefficients a_{pq} of a sub-block SB defined in FIG. 6 which does not contain the segments outside block B, the block B comprising P rows of Q pixels and m2 is the minimum of the coefficients a_{pq} of the sub-block SB, S being a threshold equal to 3 in our case, for example.
The block B belongs to the row class Cl2 if for any line p, for p=1 to P-2 of the sub-block SB:
   |m₁-m₂|<S, with:
   m₁=max{a_{pq}}_{q=1 . . . Q-2} and m₂=min{a_{pq}}_{q=1 . . . Q-2}.
   i.e. m1 is the maximum of the coefficients a_{pq} of the line p of the sub-block SB and m2 is the minimum of the coefficients a_{pq} of the line p of the sub-block SB.
The block B belongs to the class of columns Cl3 if, for any column q, for q=1 to Q-2 of the sub-block SB:
   |m₁-m₂|<S, with:
   m₁=max{a_{pq}}_{p=1 . . . P-2} and m₂=min{a_{pq}}_{p=1 . . . P-2}.
   i.e. m1 is the maximum of the coefficients a_{pq} of the column q of the sub-block SB and m2 is the minimum of the coefficients a_{pq} of the column q of the sub-block SB.
If none of the previous conditions is satisfactory, the block B belongs to the hatched class Cl4.

Starting from this stage, isolated blocks are no longer considered but horizontally and vertically adjacent pairs of blocks are. A pair of adjacent blocks (Bj,Bk) associated to a pair of classes (Clm, Cln) is then processed by a filter selection step SEL (54). This filter selection step SEL (54) delivers a filter F1 to be applied to the pair of adjacent blocks (Bj,Bk). The selection of the filter F1 is made as a function of the pair of classes (Clm, Cln) and of the degradation measure DM of the digital input image Im, based on predefined models MOD (55) which associate pairs of classes to filters as illustrated in FIG. 7 where F0 corresponds to not filtering the pair of blocks.

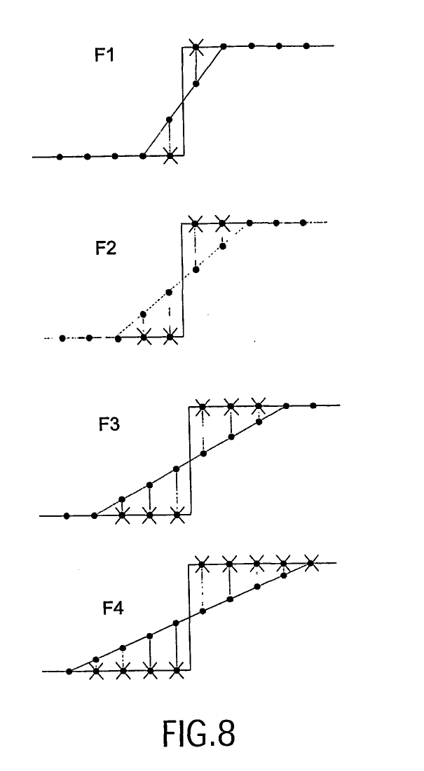

The pair of adjacent blocks (Bj,Bk) and its associated filter F1 are then presented at the input of a filter step FILT (56) which delivers a pair of adjacent filtered blocks (B′j,B′k). In our example 4 filters F1 to F4 are used. They are low-pass, linear filters and are applied either in the vertical direction or in the horizontal direction. They are represented in FIG. 8.

The pair of filtered adjacent blocks (B′j,B′k) is then subjected to a processing step (30) in accordance with that which is described in FIG. 3 so as to remove small defects of visible blocks in the moderately contrasted uniform areas.

The method according to the invention thus delivers a filtered decoded digital image ImF after processing blocks and pairs of blocks of the decoded digital image Im.

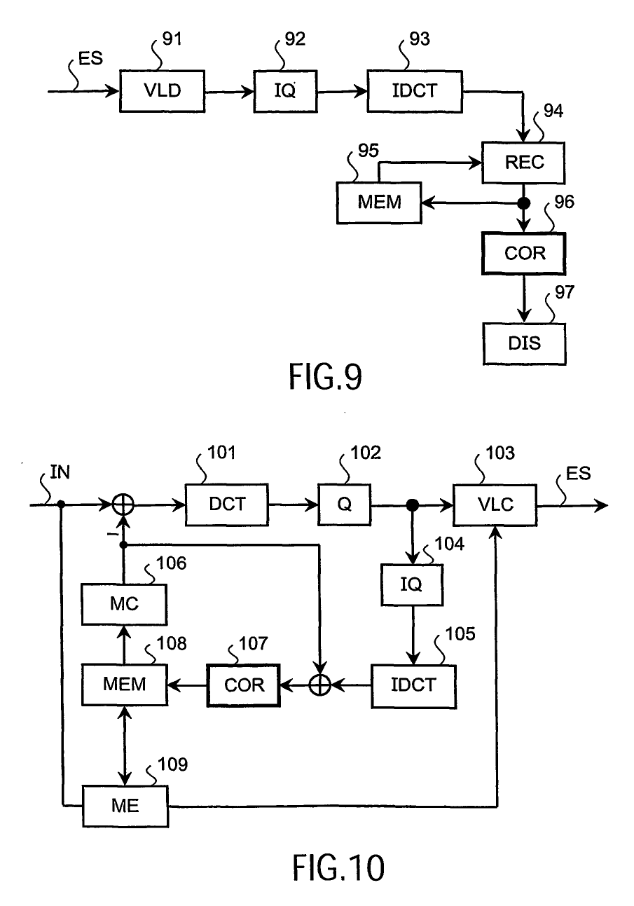

FIG. 9 illustrates the operation of a video decoder suitable for producing decoded digital images and comprising a processing device which utilizes a complete processing method according to the invention.

The video decoder comprises:
variable length decoding means VLD (91) of the coded digital data ES suitable for producing quantified data,
inverse quantizing means IQ (92) of the quantized data suitable for producing transformed data,
an inverse frequency transform device, in our example in inverse discrete cosine transform IDCT (93) of data inversely transformed data as described previously.

The decompression device further includes a reconstruction step REC (94) of the image data-block-by-data block, thanks to an image memory MEM (95). It finally comprises a processing device COR (96) which utilizes the processing method according to the invention, said device being suitable for processing the blocks of the reconstructed digital image so as to produce processed digital images in view of its display on a screen DIS (97).

FIG. 10 illustrates the operation of a video coder suitable for receiving digital images IN in the form of data blocks and comprising in the coding loop inverse frequency transform means followed by a processing device which utilizes a complete processing method according to the invention.

The video coder (100) comprises:
a direct frequency transform device here a direct discrete cosine transform DCT (101) of digital video data into transformed data, as described previously,
quantizing means Q (102) of the transformed data, suitable for producing quantized data, and
variable length coding means VLC (103) of the quantized data, suitable for producing coded data ES.

It also comprises a prediction unit comprising in a series combination:
inverse quantizing means IQ (104) of the quantized data, suitable for producing transformed data,
an inverse discrete cosine transform device IDCT (105) of transformed data, and inversely transformed data as described previously,
an adder of the data coming from the transform device IDCT and from a motion compensation device MC (106),
the processing device COR (107) utilizing the processing method according to the invention and suitable for processing blocks of decoded data coming from the output of the adder so as to supply blocks of processed data to an image memory MEM (108),
the image memory MEM (108) suitable for storing the images used by the motion compensation device MC (106) and the motion vectors resulting from a motion estimation device ME (109), and
a subtracter suitable for subtracting the data coming from the motion compensation device from the digital input video data IN, the result of this subtracter being delivered to the transform device DCT.

It may also be considered that the processing device COR (107) is inserted between the inverse discrete cosine transform device IDCT (105) and the adder, the processing being effected on a difference signal and not on a reconstructed signal.

The processing device utilizing the processing method according to the invention may thus improve the performance of a video coder notably in terms of coding quality, but also in terms of output rate. Furthermore, connecting the video coder of FIG. 10 and the video decoder of FIG. 9 in a cascade combination permits to obtain an excellent image quality much better than that obtained with a standard video coder cascaded with the video decoder of FIG. 9 or better than that of the video coder of FIG. 10 cascaded with a standard video decoder.

It is possible to implement the processing method according to the invention in a video decoder circuit or a video coder circuit, said circuit being programmed properly. A computer program contained in a program memory may cause the circuit to carry out the various operations described earlier with reference to FIG. 3 or 5. The computer program may also be loaded in the program memory by reading a data carrier such as, for example, a disc that contains said program. The reading may also be effected via a communication network such as, for example, the Internet. In this case a service provider will render the computer program available to interested parties in the form of a signal that can be downloaded.

No reference sign in brackets in the present text may be interpreted in a limiting fashion. The verb “to comprise” and its conjugations are also to be interpreted in a broad way, that is to say, not excluding the presence not only of other elements or steps than those listed after said verb, but of a plurality of elements or steps already listed after said verb and preceded by the word “a” or “an”.

1. A method of processing digital images (30) comprising data blocks, said method including
a step of determining (31) a homogeneous region which contains two adjacent blocks (Bj, Bk) whose continuous components (Lj, Lk) differ by a value lower than a predetermined threshold,
and a step of determining (32) a segment to be corrected (Sjk) comprising a set of initial data on either side of a border separating the adjacent blocks, characterized in that the method further comprises a step of replacing (33) the set of initial data of the segment to be corrected by a set (S′jk) of corrected data, said set being chosen at random from various sets of corrected data (34), an average value of a set of corrected data being substantially equal to an average value of the continuous components of the two adjacent blocks.

2. A processing method as claimed in claim 1, characterized in that the replacing step is intended to be applied to the various segments to be corrected overlapping the two adjacent blocks.

3. A processing method as claimed in claim 1, characterized in that an average value of one half of the set of corrected data is substantially equal to the average value of the continuous components of the two adjacent blocks.

4. A decoding method intended to produce decoded digital images and comprising a processing method as claimed in claim 1 for processing the decoded digital images so as to produce processed digital images.

5. A method of coding digital images in the form of data blocks, comprising an inverse frequency transformation step followed by a processing step as claimed in claim 1, suitable for processing decoded data blocks coming from the inverse frequency transformation step so as to produce processed data blocks.

6. A video decoder suitable for producing decoded digital images and comprising a processing device which utilizes the processing method according to claim 1, suitable for processing the decoded digital images so as to produce processed digital images.

7. A video coder suitable for receiving digital images in the form of data blocks and comprising inverse frequency transform means followed by a processing device which utilizes the processing method as claimed in claim 1, suitable for processing decoded data blocks coming from inverse frequency transform means so as to produce processed data blocks.

8. A portable appliance comprising a video decoder as aimed in claim 7, for displaying the processed digital images on screen of said appliance.

9. A computer program product comprising a t of instructions which, when they are loaded in a circuit, uses the circuit to carry out the method of processing digital ages as claimed in claim 1.
